(19) United States
(12) Patent Application Publication
(10) Pub. No.: US 2003/0071249 A1
(43) Pub. Date: Apr. 17, 2003

(54) Wall framing alignment tool

(76) Inventors: Isiah Clemons, Birmingham, AL (US); James C. Nolan, Birmingham, AL (US)

Correspondence Address: ISIAH CLEMONS, 1313 OAK TERRACE, BIRMINGHAM, AL, 35235, US

(21) Appl. No.: 09/976,924

(22) Filed: Oct. 15, 2001

(51) Int. Cl. B66F 3/00

(52) U.S. Cl. 254/17

(57) ABSTRACT

A wall frame alignment tool for use in construction of wood framing is disclosed. An elongated tubular body has first and second end portions. A first wedge portion tapering to a sharply pointed tip is attached to the second end portion. A first hole is located between said tubular body and said wedge portion for attachment of an L-shaped plate pivotably mounted on said tubular body adjacent said second end wedge portion. A hole in the L-shaped plate is aligned with the first hole for placement of a hinge pin therethrough. A connecting leg of the L-shaped plate projects laterally from the tubular body at the hinge pin connection point at a first end. A downleg depends from the connecting leg at a second end. The downleg terminaties in a second wedge portion tapering to a sharp point at the end opposite said connecting leg. First wedge point is forcibly engageable with a flat wooden surface, and said second point forcibly engageable with an adjacent wall baseplate situated on said surface, to pull the baseplate and wall frame connected thereto, into a desired alignment by applying a forward or backward torque to said first end of said tubular body.

### BACKGROUND OF THE INVENTION

1. Field of the Invention

The present invention relates generally to wall framing tools, and more particularly to a carpenter's tool for pulling into alignment a wall frame structure, along a horizontal line.

2. Description of the Related Art

Wall pulling tools are known in the prior art. Most residential housing is constructed using walls framed with 2×4 boards, which in actual dimension are 1½″ to 1⅝″ thick, and 3⅝″ wide. Board lengths vary from 8′ to 12′ standard lengths, and of course may be cut to any desired custom length. The baseplate board, which is the bottom horizontal board to which the vertical boards are nailed, is also used to align the wall along the building lines. It is therefore necessary to pull the baseplate into alignment with the building line. This is sometimes made more difficult by the weight of the wall frame, when the wall has been framed elsewhere, and is being set into position.

U.S. Pat. No. 4,290,582 issued to Eckelkamp discloses a wall puller tool. A steel pin like shaft has a sharply pointed bottom end adapted to be struck into a plywood floor. A pivotable laterally extending claw-like arm has a downward perpendicular extending pointed end adapted to be struck into plate member. The tool is operated by the elongated handle to drag the plate member toward the pivot point. The tool is used by either pulling or pushing the wall base plate to the desired alignment.

U.S. Pat. No. 4,493,477 issued to Greer discloses a carpenter's tool for use in construction of wood framed structures having an elongated handle with one end sharpened for penetration into wood and a baar pivoted to the handle adjacent the sharpened end. A sharpened member at the outer extremity of the bar has a tip extending in the direction of the sharpened tip of the handle.

U.S. Pat. No. 3,779,515 issued to Larios, et. al. discloses an adjustable decking and framing tool. A horizontal base bar is pivotally connected at one end with a vertical lever arm having a point engageable with a wooden structure. A spike attachment is adapted for pushing and pulling movements to align erected wall frames on a floor.

### SUMMARY OF THE INVENTION

What is disclosed is a wall frame alignment tool for use in construction of wood framing. An elongated tubular body has first and second end portions. A first wedge portion tapering to a sharply pointed tip is attached to the second end portion. A first hole is located between said tubular body and said wedge portion for attachment of an L-shaped plate pivotably mounted on said tubular body adjacent said second end wedge portion. A hole in the L-shaped plate is aligned with the first hole for placement of a hinge pin therethrough. A connecting leg of the L-shaped plate projects laterally from the tubular body at the hinge pin connection point at a first end. A downleg depends from the connecting leg at a second end. The downleg terminaties in a second wedge portion tapering to a sharp point at the end opposite said connecting leg.

First wedge point is forcibly engageable with a flat wooden surface, and said second point forcibly engageable with an adjacent wall baseplate situated on said surface, to pull the baseplate and wall frame connected thereto, into a desired alignment by applying a forward or backward torque to said first end of said tubular body.

It is an object of the present invention to provide a device which may be used to pull a wall frame into alignment with a desired line. It is another object of the invention is to provide a tool for a carpenter which will enable an individual to pull a wall frame into alignment unassisted.

### DESCRIPTION OF THE DRAWINGS

FIG. 1 is a perspective view of the wall framing tool;

FIG. 2 is a front elevational view;

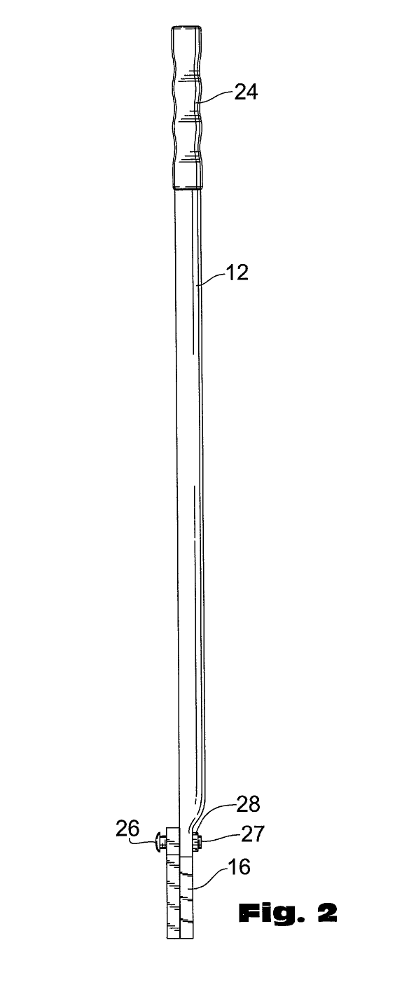

FIG. 3 is a perspective view of the device in a first position; and

FIG. 4 is a perspective view of the device moving a wall frame.

### DETAILED DESCRIPTION OF THE INVENTION

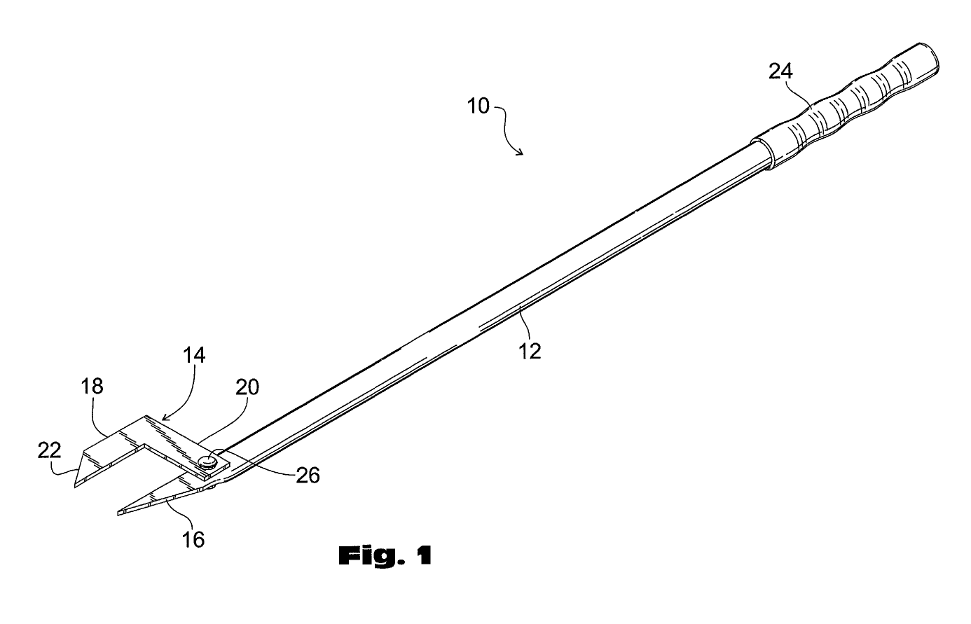

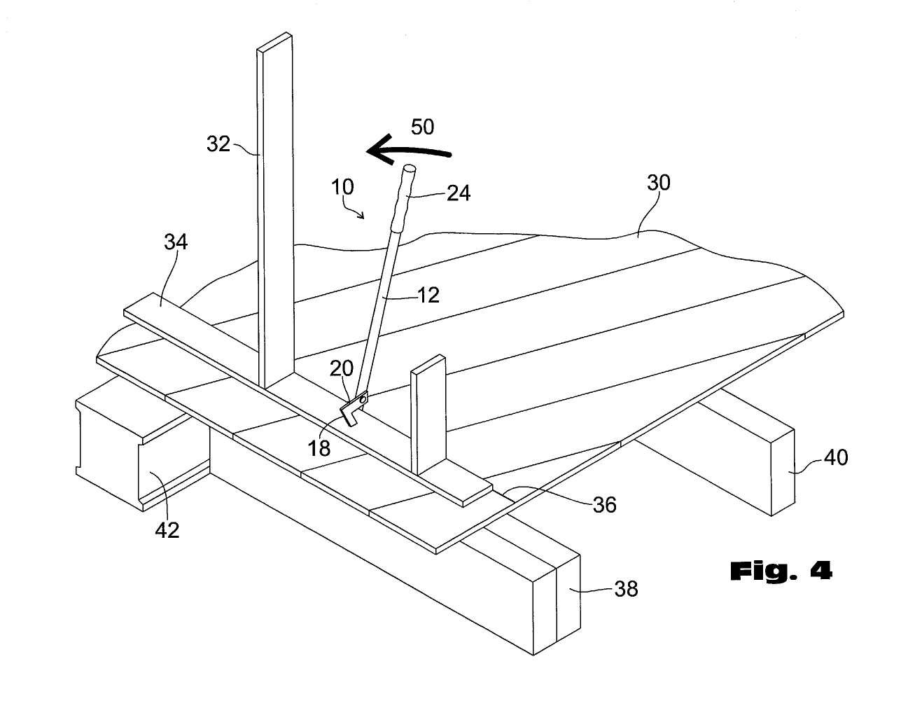

Referring first to FIG. 1, a wall framing alignment tool 10 is shown. A longitudinal, tubular shaft 12 has opposing ends 24, 16. End 24 has is equipped with a rubber grip 24 to facilitate manually grasping the tool without the user's hand slipping off of the shaft 12. Shaft 12 ends at impinging point 16, a sharply tapered end coming to a point. A connecting leg 20 is attached adjacent impinging point 16 by pivot lug 26. Connecting leg 20 extends outwardly in a hinged fashion to a downleg 18 which also includes an impinging point 22. Connecting leg 20 and downleg 18 form an L-shaped plate 14. When L-shaped plate 14 is placed above a 2×4 base plate of a wall base plate 34, as illustrated in FIG. 4, for example, downleg 18 impinges on wall base plate 34. Impinging point 16 engages the deck boards 30, generally comprised of a series of adjacent flat boards, the shaft 12 acts as a lever. The lever can be used to push or pull in the desired direction 50 in order to align wall base plate 34 with a plumb 36.

Referring next to FIG. No. 2, a front view of the wall framing alignment tool is shown. From the front view, the rubber end grip 24 is visible, slidably affixed on one end of shaft 12. At the lower end of shaft 12 is seen the pivotal connection point wherein pivot lug 26 extends through plate 14 and shaft 12 adjacent impinging point 16. A threaded end 27 of pivot lug 26 is fastened by means of lug nut 28.

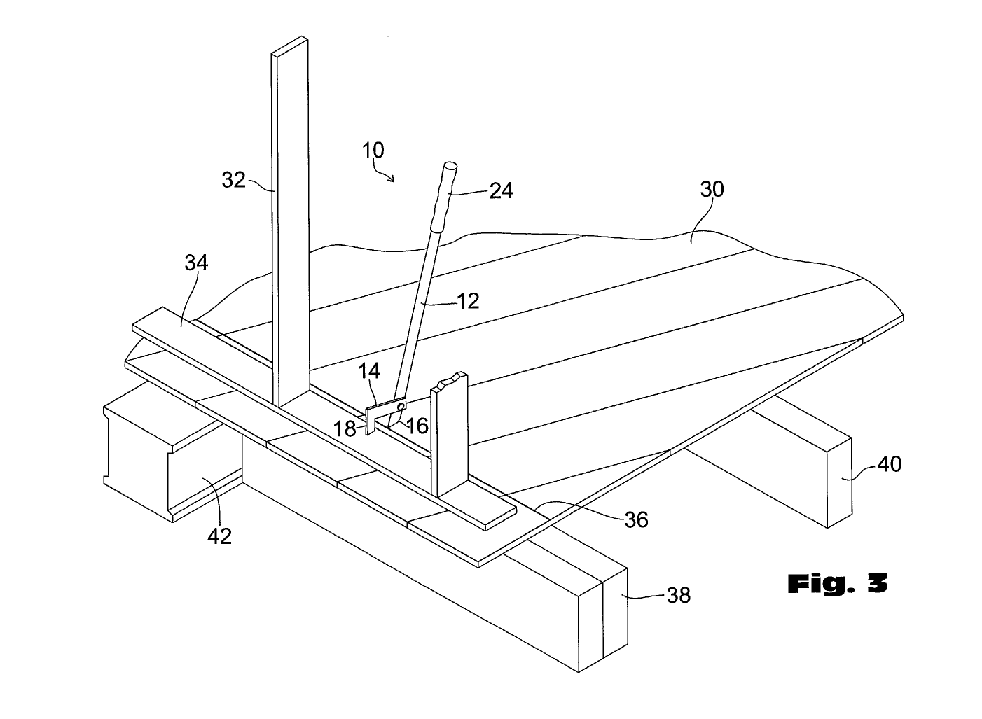

Referring next to FIG. 3 an illustration of the usage of the wall framing alignment tool is shown. Impinging point 16 impinges with deck boards 30 and L-shaped plate 14 extends outwardly such that downleg 18 impinges the wall base plate 34. A gap between the base plate 34 and the plumb line 36 exists in this illustration. By grasping the rubber grip 24 at the opposite end of shaft 12, and pulling backwards, wall base plate 34 is urged towards plumb line 36. The deck boards 30 are supported upon floor joists 38 and joist 40, which in turn are structurally connected to main beam 32. Vertical wall studs 32 form the internal braces of the wall frame to which drywall is affixed at a later time. Thus, the tool 10 is utilized to align wall base plate 34 along in very close alignment with plumb line 36.

Referring next to FIG. 4, the illustration as set forth in FIG. 3 is shown wherein the tool 10 is forcibly leveraged in the direction of arrow 50 to further urge the wall base plate along the plumb line 36. The tool works by setting the impinging point 16 at its point on top of plumb line 36 while the board is within reach of the downleg 18 point 22. The shaft 12 is angled backwards towards the operator. As the operator urges the top of shaft 12 forward towards the wall downleg 18 and L-shaped plate 14 are caused to rotate the angle of the L-shaped plate with shaft 12 to pull the wall base plate 34 back towards shaft 12 until wall base plate is touching impinging point 16.

Thus the tool is effective by either pushing or pulling as long as point 16 is fixedly engaged with the deck boards 30. By this method, the wall base boards may be moved into place at several points along the plumb line 36 until a nearly perfect alignment is achieved. This procedure can then be followed by all four or more adjoining walls as the case may be. Various changes and modifications may be made with this invention which will be readily apparent to one skilled in the art. It should be understood that such changes and modifications fall within the scope in teaching this invention and should be defined by the claims as appended hereto.

According to the provisions of the patent statutes, I have explained the principle, preferred constructed, and mode of operation of my invention, and have illustrated and described what I know and consider to represent its best 001.embodiments. However, it should be understood that within the scope of the appended claims, the invention may be practiced, otherwise that specifically illustrated and described.

We claim:

1. A wall frame alignment tool for use in construction of wood framing, comprising:
an elongated tubular body having first and second end portions, and a first wedge portion tapering to a sharply pointed tip attached to said second end portion; and a first hole located between said tubular body and said wedge portion,
an L-shaped plate pivotably mounted on said tubular body adjacent said end wedge, and having a second hole aligned with said first hole for placement of a hinge pin therethrough; a connecting leg extending laterally from said tubular body at said hinge pin connection point at a first end; a downleg depending from said connecting leg at a second end; said downleg terminating in a second wedge portion tapering to a sharp point at the end opposite said connecting leg;
such that said first wedge point is forcibly engageable with a flat wooden surface, and said second point forcibly engageable with an adjacent wall baseplate situated on said surface, to pull the baseplate and wall frame connected thereto, into a desired alignment by applying a forward or backward torque to said first end of said tubular body.

2. The apparatus for cooking as set forth in claim 1, wherein said tool also having a rubber grip portion covering said first end portion,
